(19) United States
(12) Patent Application Publication
(10) Pub. No.: US 2026/0313476 A1
(43) Pub. Date: Oct. 8, 2026

(54) SMART Xn MOBILITY HANDLING IN 5G STANDALONE O-RAN WIRELESS COMMUNICATION NETWORK

(71) Applicant: DISH Wireless L.L.C., Englewood, CO (US)

(72) Inventor: Manish Uniyal, Parker, CO (US)

(21) Appl. No.: 19/170,834

(22) Filed: Apr. 4, 2025

(51) Int. Cl. H04W 36/00

(52) U.S. Cl. CPC H04W 36/0055

(57) ABSTRACT

A method for managing Xn interface mobility in a wireless communication network includes determining a number of Xn interfaces for a source gNodeB (gNB) and a number of Xn relationships for cells for the source gNB, determining when an Xn limit is reached based on one or more of the number of Xn interfaces for the source gNB and the number of Xn relationships for cells for the source gNB, generating a notification when the Xn limit is reached, identifying a set of one or more candidate Xn interfaces of the source gNB based on a predetermined status, when at least one of the candidate Xn interfaces is removable, removing the at least one removable candidate Xn interface, and performing a handover of a user equipment (UE) device from the source gNB to a target gNB using one of the Xn interfaces of the source gNB.

### BACKGROUND

Wireless communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a system for managing Xn interface mobility in a wireless communication network includes a memory that stored one or more computer readable media that includes instructions and one or more processor devices configured to execute the instructions of the computer readable media to determine a number of Xn interfaces for a source gNodeB (gNB) and a number of Xn relationships for cells for the source gNB, determine when an Xn limit is reached based on one or more of the number of Xn interfaces for the source gNB and the number of Xn relationships for cells for the source gNB, generate a notification when the Xn limit is reached, identify a set of one or more candidate Xn interfaces of the source gNB based on a predetermined status, and when at least one of the candidate Xn interfaces is removable, remove the at least one removable candidate Xn interface. The one or more processor devices are configured to further execute the instructions of the computer readable media to perform a handover of a user equipment (UE) device from the source gNB to a target gNB using one of the Xn interfaces of the source gNB.

In accordance with another embodiment, a method for managing Xn interface mobility in a wireless communication network includes determining, using a processor device, a number of Xn interfaces for a source gNodeB (gNB) and a number of Xn relationships for cells for the source gNB, determining, using the processor device, when an Xn limit is reached based on one or more of the number of Xn interfaces for the source gNB and the number of Xn relationships for cells for the source gNB, generating, using the processor device, a notification when the Xn limit is reached, identifying. using the processor device, a set of one or more candidate Xn interfaces of the source gNB based on a predetermined status, and when at least one of the candidate Xn interfaces is removable, removing, using the processor device, the at least one removable candidate Xn interface. The method further includes performing, using the processor device, a handover of a user equipment (UE) device from the source gNB to a target gNB using one of the Xn interfaces of the source gNB.

In accordance with yet another embodiment, a non-transitory, computer-readable medium storing instructions that, when executed by a processor perform a set of functions for managing Xn interface mobility in a wireless communication network, the set of functions including determining a number of Xn interfaces for a source gNodeB (gNB) and a number of Xn relationships for cells for the source gNB, determining when an Xn limit is reached based on one or more of the number of Xn interfaces for the source gNB and the number of Xn relationships for cells for the source gNB, generating a notification when the Xn limit is reached, identifying a set of one or more candidate Xn interfaces of the source gNB based on a predetermined status, and when at least one of the candidate Xn interfaces is removable, removing the at least one removable candidate Xn interface. The set of functions further includes performing a handover of a user equipment (UE) device from the source gNB to a target gNB using one of the Xn interfaces of the source gNB.

### BRIEF DESCRIPTION OF THE DRAWINGS

The present disclosure will hereafter be described with reference to the accompanying drawings, wherein like reference numerals denote like elements.

FIG. 1 is a schematic block diagram of an example wireless communication network in accordance with an embodiment;

FIG. 2 is a schematic block diagram of an example of a service-based architecture of a wireless communication network in accordance with an embodiment;

FIG. 3A is a block diagram of an example NG-RAN with a plurality of gNBs in a wireless communication network in accordance with an embodiment;

FIG. 3B is a block diagram of an example NG-RAN with a plurality of gNBs and Xn interfaces in accordance with an embodiment;

FIG. 4 illustrates a method for managing Xn interface mobility in a wireless communication network in accordance with an embodiment; and

FIG. 5 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

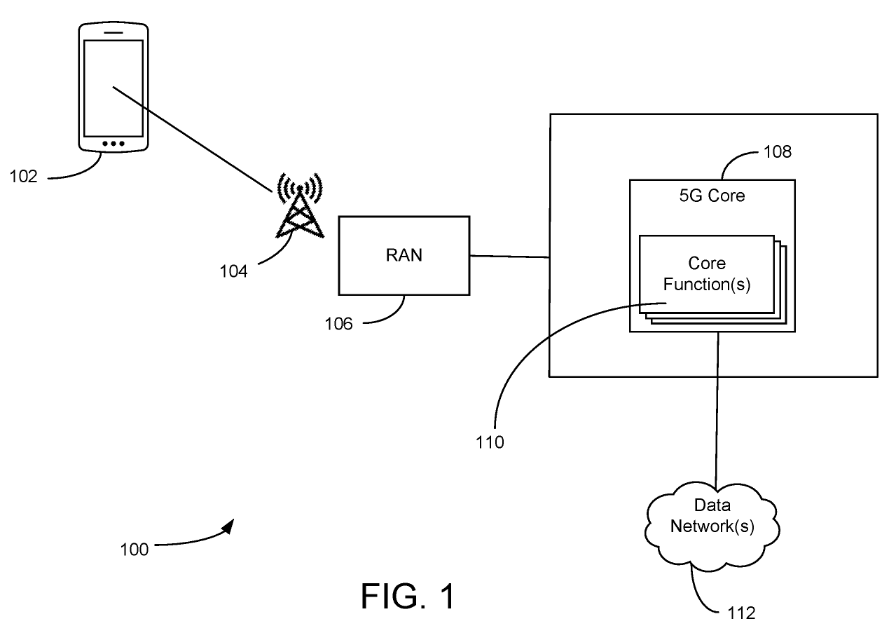

FIG. 1 is a schematic block diagram of an example wireless communication network in accordance with an embodiment. The wireless communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNs) 112 (e.g., the Internet or a private corporate network) using the RAN 106 and 5G core 108. For example, if the external data network 112 is the Internet, the RAN 106 and 5G core 108 can allow the UE device 102 to send and receive data via the Intern et. While FIG. 1 illustrates various components of wireless communication network 100, other embodiments of wireless communication network 100 can vary the arrangement, communication paths, and specific components of wireless communication network 100. In some embodiments, the wireless communication network 100 can include fewer, additional, or different components in different configurations than illustrated in FIG. 1. For example, in some embodiments, the wireless communication network 100 may include additional or different UE devices 102.

The wireless communication network 100 may be used to facilitate multiple types of communication sessions, such as, for example, voice calls, video calls, messaging, data transmission, and/or other types of communications. In some embodiments, the wireless communication network 100 can be configured to implement IP multimedia services or subsystems (IMS) for delivering multimedia communication services such as, for example, voice, video, and text messaging over IP networks. The wireless communication network 100 may represent a portion of a wireless network built around 5G (fifth generation) standards promulgated by standards setting organizations under the umbrella of the Third Generation Partnership Project (3GPP). Accordingly, in some configurations, the wireless communication network 100 may be a 5G network, such as, for example, a 5G cellular network. Such 5G networks, including the wireless communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a cloud-native 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computer resources. Such general purpose computing resources can be part of a public cloud-computing platform that provides virtual private clouds (VPCs) for multiple clients. On a hybrid cellular network, RAN components of the cellular network are in communication with components of the cellular network executed on a public cloud computing platform such as Amazon Web Services (AWS).

In some configurations, the wireless communication network 100 may be a standalone (SA) network (e.g., a 5G SA network) that utilizes 5G cells for both signaling and information transfer via a 5G packet core architecture. In other configurations, the wireless communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the wireless communication network 100. While FIG. 1 illustrates one UE device 102, in some embodiments, it should be understood that the wireless communication network 100 can support a plurality of UE devices 102. UE device 102 can be various forms of wireless devices that are capable of communication according to the radio access technology (RAT) of the wireless communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the wireless communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on wireless communication networks. For example, after the UE device 102 has established a connection or session with the RAN 106, a user of the UE device 102 may select to stream a video on an application of the UE device 102 via the Internet (e.g., data network 112). The video stream can be provided to the UE device 102 on data packets.

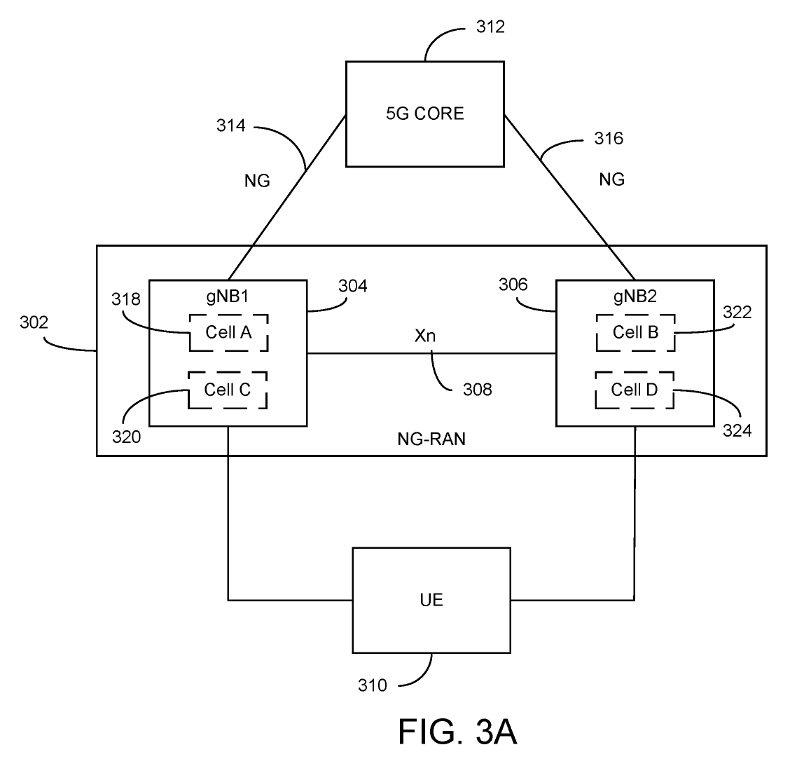

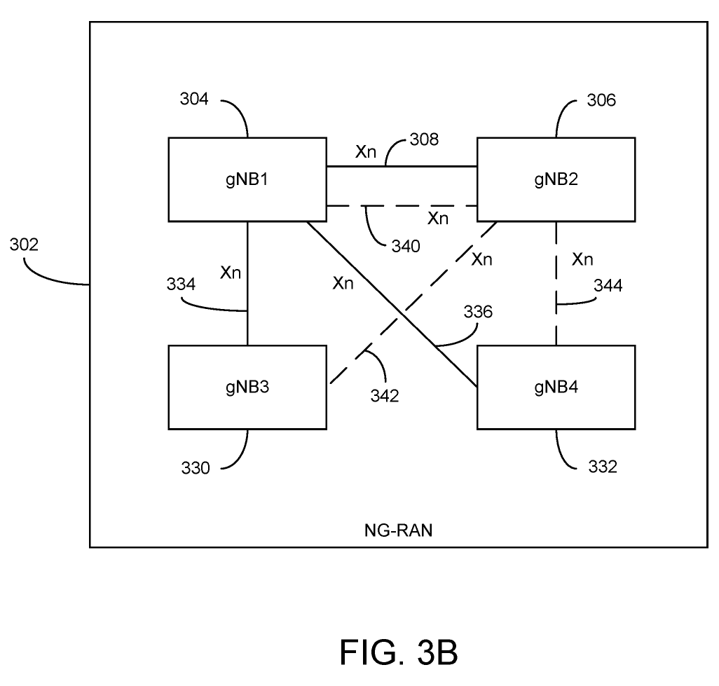

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3GPP 5G next generation base station that supports communications with the UE device 102. The radio transceiver 104 and the RAN 106 (e.g., virtualized RAN components) may collectively be referred to as a next-generation RAN (NG-RAN). While FIG. 1 illustrates a single radio transceiver 104 and a single RAN 106, in practical implementations the wireless communication network 100 may include any number of radio transceivers 104 and/or any number of RAN 106. As discussed further below with respect to FIG. 3, in some embodiments, a RAN 106 (or NG-RAN) can include a plurality of gNBs (or nodes).

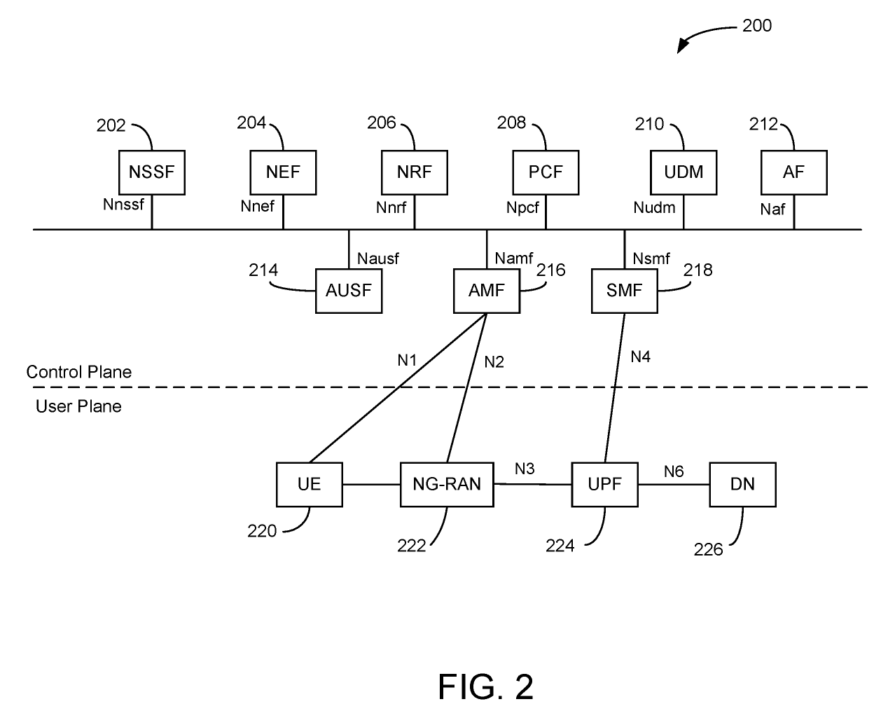

The 5G Core 108 may include one or more core functions 110. Each core function 110 can be a network function (NF) that provides a utility or service specific to the 5G core 108, for example, core functions of the wireless communication network 100. In some embodiments, for example, different NFs may provide different utility to the wireless communication network 100. In some embodiments, the 5G core 108 including the core functions 110 can reside on a cloud computing platform. For example, in some embodiments, the wireless communication network (e.g., wireless communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Examples of various core functions 110 are discussed further below with respect to FIG. 2. In some embodiments, the RAN 106 and the 5G core 108 (including core functions 110) may be implemented on a computer system (e.g., computer system 600 discussed below with respect to FIG. 6) such as a server or the functionality of the RAN 106 , the 5G core 109 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC, for example, in a region-based network topology (discussed further below). Within an NDC, multiple regional data centers (RDCs) can be logically present. In some embodiments, each of such one or more regional data centers may execute core functions 110 for a different geographic region or a group of RAN components.

As mentioned, in some embodiments, the wireless communication network 100 can be configured according to a region-based topology. For example, the wireless communication network 100 may be implemented using a cloud computing platform that is logically and physically divided up into various different cloud computing regions (e.g., AWS regions). The cloud computing regions may be based on geographical location of the gNbs; for example, the wireless communication network 100 for a given nation may be divided into a number of geographical regions. Each of the cloud computing regions can be isolated from other cloud computing regions to help provide fault tolerance, fail-over load-balancing, and/or stability and each of the cloud computing regions can be composed of multiple availability zones (AZs) or markets, each of which can be a separate data center located in general proximity to each other (e.g., within 100 miles). For example, one cloud computing region may have its data centers and hardware located in the northeast of the United States while another cloud computing region may have its data centers and hardware located in California. Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service.

FIG. 2 is a schematic block diagram of an example of a service-based architecture (SBA) of a wireless communication network in accordance with an embodiment. The SBA 200 includes an infrastructure domain that is divided between a control plane and a user plane. The control plane includes a plurality of network functions (NFs) 202-218. The user plane includes a UE 220 (e.g., UE 102 shown in FIG. 1) in communication with an NG-RAN 222, and NFs (e.g., UPF 224). In FIG. 2, the SBA 200 can be used for providing communication between the UE device 220 and a data network 226 (e.g., the Internet). In FIG. 2, the example 5G core architecture is simplified to show some key components, however, implementations can involve additional components. In some embodiments, the wireless communication network (e.g., wireless communication network 100 shown in FIG. 1), or portion thereof, in which the 5G core is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). For ease of illustration, FIG. 2 only shows a single UE 220 being connected to the RAN 222, however, in practical implementations any number of UEs 220 can be present, limited only by the capacity of the network.

In the example architecture illustrated in FIG. 2, the NFs can include a Network Slice Selection Function (NSSF) 202, a Network Exposure Function (NEF) 204, a Network Repository Function (NRF) 206, a policy control function (PCF) 208, a Unified Data Management (UDM) function 210, an Application Function (AF) 212, an Authentication Server Function (AUSF) 214, an Access and Mobility Management Function (AMF) 216, a Session Management Function (SMF) 218, and a User Plane Function (UPF) 224. The NSSF 202 can provide tailor made logical networks on the physical network, for example, the NSSF can be used by the AMF 216 to assist with the selection of a network slice that will serve a particular UE device. The NEF 204 can expose services and resources over application programming interfaces (APIs) within and outside the 5G core. The NRF 206 can enable 5G network functions (NFs) to register and discover each other via a standards-based application programming interface (API). The PCF 208 can apply session policies for the UE device 220, or other devices, when connecting over, for example, 5G. The UDM 210 can manage network user data in a single, centralized element and can allow for generation of authentication vectors, user identification handling, NF registration management, and retrieval of UE device individual subscription data for slice selection. The AF 212 can interact with the 3GPP Core Network in order to provide services, for example, to support one or more of application function influence on traffic routing, application function influence on service function chaining, accessing the NRF 212, interacting with the PCF 216, time synchronization service, IP multimedia subsystem (IMS) interactions with the 5G core, or packet data unit (PDU) set handling. The AUSF 214 can allow the AMF 216 to authenticate the UE and access services of the 5G core. The AMF 216 can perform operations like mobility management, registration management, connection management, UE-based authentication, etc. The SMF 218 can interact with the decoupled data plane, can perform internet protocol (IP) address allocation and management for UE devices (e.g., UE device 220), user plane selection, and packet routing in conjunction with the UPF 224, etc. The UPF 224 can perform user plane operations, such as maintaining protocol data unit (PDU) sessions, packet routing and forwarding, inspection policy enforcement for the user plane, Quality of Service (QoS) handling, providing data access to the UE 220, etc. A PDU session can provide connectivity between applications on the UE device 220 and the DN 226 (e.g., the Internet). The SMF 218 can also be responsible for creating, updating, and removing PDU sessions, selecting particular UPFs 224 on which to anchor PDU sessions when new UE devices 220 appear on the wireless communication network, and managing session context with the UPF 224. Together with the UPF 224, the SMF 218 can maintain a record of PDU session state by means of a PDU Session ID.

The SBA 200 may also include a plurality service-based interfaces (SBIs) to provide access to or communicate with the various NFs. As illustrated, such service-based interfaces may include an Nnssf interface for the NSSF 202, an Nnef interface for the NEF 204, an Nnrf interface for the NRF 206, an Npcf interface for the PCF 208, an Nudm interface for the UDM 210, an Naf interface for the AF 212, an Nausf interface for the AUSF 214, an Namf interface for the AMF 216, and an Nsmf interface for the SMF 218. In some embodiments, the UE 220 can communicate with the NG-RAN 222 wirelessly, for example, via a radio transceiver 104 (shown in FIG. 1). The AMF 216 and the UE 220 can communicate signals or messages with another over, for example, an N1 interface. The AMF 216 and the NG-RAN 222 can communicate signals or messages with one another over, for example, an N2 interface. The NG-RAN 222 and the UPF 224 can communicate signals and data with one another over, for example, an N3 interface. The SMF 218 and the UPF 224 can communicate signals or messages with one another over, for example, an N4 interface. The UPF 224 can send and receive signals and data with a data network 226 (e.g., the Internet) over, for example, an N6 interface. The AMF 216 and the SMF 218 can communicate signals and messages with one another over an interface, for example, an N11 interface. Any of the above described interfaces may be an SBI interface (e.g., an http2 based interface).

The above-listed NFs and interfaces are intended to be illustrative and not exhaustive. In practical implementations, the SBA 200 may include additional NFs and other network entities, such as an SNPN Authentication and Authorization Function (NSSAAF), a Network Data Analytics Function (NWDAF), a United Data Repository (UDR), a 5G-Equipment Identity Register (5G-EIR), a Charging Function (CHF), a Service Communication Proxy (SCP), a Security Edge Protection Proxy (SEPP), a Hone Subscriber Service (HSS), a Home Location Register (HLR), a Binding Support Function (BSF), a Policy and Charging Rules Function (PCRF), a Call Session Control Function (CSCF), a Session Border Control Function (SBC), a Media Resource Function (MRF), a Short Message Service Function (SMSF), a Rich Communication Services Application (RCS), an Authentication, Authorization, and Accounting (AAA) service, or a Diameter Routing Agent (DRA). Any of the NFs illustrated in FIG. 2 and/or described above may be implemented as a software unit residing on a server (i.e., in the cloud).

In the SBA 200 shown in FIG. 2, the NG-RAN 222 may include some or all of the virtualized RAN components 106 discussed above with respect to FIG. 1. Thus, the NG-RAN 222 may include at least one CU, at least one DU configured to operate under the control of one or more of the at least one CU, and at least one RU configured to operate under the control of one or more of the at least one DU. In some embodiments, NG-RAN 222 can include a plurality of gNBs (or nodes). FIG. 3A is a block diagram of an example NG-RAN with a plurality of gNBs in a wireless communication network in accordance with an embodiment. In FIG. 3A, an NG-RAN 302 (e.g., NG-RAN 222 shown in FIG. 2) is in communication with a UE 310 (e.g., UE 220 shown in FIG. 2) and a 5G core 312 (e.g., 5G core 108 shown in FIG. 1). As illustrated in FIG. 3A, the NG-RAN 302 includes a plurality of gNBs (or nodes), in particular, a first gNB 304 and a second gNB 306. Although FIG. 3A illustrates two gNBs 304, 306, in practical implementations any number of gNBs may be present in NG-RAN 302. An Xn interface (or link) 308 can be provided between gNB1 304 and gNB2 306 for the interconnection of the two gNBs 304, 306. An NG interface may be used to provide a logical connection and enable communication between the NG-RAN 302 and to the 5G core 312. In some embodiments, an NG interface may be provided between each gNB of the NG-RAN and the 5G core 312, for example, as illustrated in FIG. 3A, an NG interface 314 can be provided between the first gNB 304 and the 5G core 312 and an NG interface 316 can be provided between the second gNB 306 and the 5G core 312.

The Xn interface 308 facilitates communication (e.g. signaling) and data transfer between the two gNBs. In some embodiments, the Xn interface 308 can encompass both the control place (discussed above with respect to FIG. 2) and the user plane (discussed above with respect to FIG. 2). For example, the control plane can handle signaling and the user plane can manage the transfer of application data. General principles for an Xn interface include, for example, the Xn interface is open, the Xn interface supports the exchange of signaling information between two NG-RAN nodes (e.g., gNB 304 and gNB 306 of NG-RAN 302) and the forwarding of PDUs to the respective tunnel endpoints, and from a logical standpoint the Xn interface is a point-to-point interface between two NG-RAN nodes (e.g., gNB 304 and gNB 306 of NG-RAN 302). In some embodiments, a point-to-point logical interface can be feasible even in the absence of a physical direct connection between two NG-RAN nodes (e.g., gNB 304 and gNB 306 of NG-RAN 302).

In embodiments where the NG-RAN 302 includes more than two gNBs (or nodes), each gNB in the NG-RAN 302 can access and communicate with each of the other gNBs in the NG-RAN 302 as illustrated in FIG. 3B. FIG. 3B is a block diagram of an example NG-RAN with a plurality of gNBs and Xn interfaces in accordance with an embodiment. In FIG. 3B, the example NG-RAN 302 is illustrated with four gNBs, namely, a first gNB 304, a second gNB 306, a third gNB 330 and a fourth gNB 332. Although FIG. 3B illustrates four gNBs, in practical implementations any number of gNBs may be present. The first gNB 304 can have a first Xn interface 308 to the second gNB 304, a second Xn interface 334 to the third gNB 330, and a third Xn interface 336 to the fourth gNB 332. The second gNB can also have an Xn interface (shown with dashed lines in FIG. 3B) to each of the other gNBs 304, 330, 332 of the NG-RAN 302. As illustrated in FIG. 3B, the second gNB can have an Xn interface 340 to the first gNB, a second Xn interface 342 to the third gNB 330, and a third Xn interface 344 to the fourth gNB 332. While not shown in FIG. 3B for simplicity, it should be understood that the third gNB 330 can have an Xn interface to each of the first gNB 304, the second gNB 306 and the fourth gNB 332, and the fourth gNB 332 can have an Xn interface to each of the first gNB 304, the second gNB 306 and the third gNB 330.

Returning to FIG. 3A, each gNB 304, 306 in the NG-RAN can include a plurality of cells (e.g., n cells). For example, in the example illustrated in FIG. 3A, the first gNB 304 can include a cell A 318 and a cell C 320 and the second gNB 306 can include a cell B 322 and a cell D 324. An Xn interface such as, for example, Xn interface 308 between the first gNB 304 and the second gNB 306, can be configured to handle a plurality of relationships (or relationship links) between cells of the two gNBs interconnected by the Xn interface. For example, Xn interface 308 can be used to facilitate communication and data transfer for a first relationship between cell A 318 of the first gNB 304 and cell B 322 of the second gNB 306, and for a second relationship between cell C 320 of the first gNB 304 and cell D 324 of the second gNB 306. While only two cells for each gNB 304, 306 is shown in FIG. 3A, it should be understood that each gNB can include any number of cells as, for example, defined by an administrator of the wireless communication network.

In some embodiments, the Xn interface (e.g., Xn interface 308) between two gNBs (e.g., the first gNB 304 and the second gNB 306) can also be used to facilitate a handover of one or more UE devices between two gNBs, namely a source gNB and a target gNB. A handover is the transferring of communication between a UE and the NG-RAN from a communication pathway that includes a source gNB to another communication pathway that include a target gNB neighboring the source gNB. Transference of the communication to the communication pathway that includes the target gNB neighboring the source gNB concludes the handover. Upon the transference of communication, the target gNB will become a newly-designated source gNB and the gNB that was previously the source gNB will become another target or candidate gNB. For example, in FIG. 3A, Xn interface 308 can be used to facilitate a handover of UE 310 from the first gNB 304 (i.e., the source gNB) to the second gNB 306 (i.e., the target gNB). In some embodiments, an Xn interface can handle multiple UE handovers between two gNBs. For example, the Xn interface 308 can be configured to handle handovers for a plurality of UEs (e.g., handovers for other UE’s in the wireless communication network other than UE 310) the first gNB 304 and the second gNB 306. In addition, an Xn interface can handle a handover for each relationship (or relationship link) for the cells of the gNB. For example, Xn interface 308 can be configured to handle a handover between cell A 318 of the first gNB 304 and cell B of the second gNB 306, and a handover between cell C of the first gNB 304 and cell D of the second gNB 306. The NG interface(s) 314, 316 can also be configured to facilitate a handover of one or more UE devices between two gNBs, for example, a source gNB and a target gNB. As discussed further below, an NG-based handover can be utilized when an Xn interface is failing or not available. An NG-based handover may have certain delays compared to an Xn-based handover, however, the delays may not have a perceptible impact on the user experience.

In some embodiments, a limit on the number of Xn interfaces (or links) for a gNB (e.g., the Xn interface capacity of the gNB) and a limit on the number of Xn relationships for a gNB (and each Xn interface of the gNB) can be defined or established, for example, by an administrator of the wireless communication network including the gNBs. As used herein, the term “Xn limit” may refer to one or more of a limit on the number of Xn interfaces (or links) for a gNB (e.g., the Xn interface capacity of the gNB) or a limit on the number of Xn relationships for a gNB (and each Xn interface of the gNB). In some embodiments, for example, an Xn limit may be defined during the design of the wireless communication network (e.g., the number of gNBs (or nodes)) and can be based on, for example, the number of gNBs required for one or more high traffic areas in the wireless communication network. In some embodiments, the Xn limit for the number of Xn interfaces (or links) for a gNB may be less than the Xn limit for the number of Xn relationships for a gNB. For example, a gNB may have an Xn limit for the number of Xn interfaces (or links) of 16 or 32, and the gNB may have an Xn limit for the number of Xn relationships of 256 or 512. If a gNB does not support enough Xn interfaces or Xn relationships, or if an Xn interface or Xn relationship is added that causes the total number of Xn interfaces or Xn relationships to exceed the Xn limit for the gNB, problems or issues may be experienced which can negatively impact or affect communications services provided by the wireless communication network and degrade end user experience. For example, the mobility handling (e.g., handover performance) of the gNB can be degraded, one or more handovers may fail, and one or more applications may crash.

The present disclosure describes a system and method for managing Xn interface mobility to avoid issues with Xn mobility as well as end user experience. In some embodiments, the current number of Xn interfaces of a gNB (e.g., a source gNB for a handover) and/or the current number of Xn relationships for cells of the gNB can be determined and compared to an Xn limit for number of Xn interfaces of the gNB and/or Xn limit for the number of n relationships for cells of the gNB to determine if the Xn limit has been reached or exceeded. If the Xn limit has not been reached, a handover of UE device can be performed using one of the Xn interfaces of the gNB (e.g., a source gNB). If the Xn limit has been reached (e.g., either for the number of Xn interfaces of the gNB and/or for the number of Xn relationships for cells of the gNB), a notification (or alarm) can be generated. In addition, in some embodiments, a set of candidate Xn interfaces (including Xn relationships) can be automatically identified that have a predetermined status, for example, an age or level of use of the Xn interface. For example, older Xn interfaces or Xn relationships of the gNB (e.g., the source gNB for a handover)) and/or Xn interfaces or Xn relationships of the gNB that are currently unused or infrequently used can be identified. If one or more of these candidate Xn interfaces of the gNB can be removed or deleted, the at least one Xn interface can be removed and the handover of the UE device can be performed using one of the remaining Xn interfaces of the Xn interface (including one or more newly added Xn interfaces). If none of the candidate Xn interfaces (including Xn relationships) can be removed, a handover of the UE device can be performed using an NG interface (or interfaces) between the source and target gNB and a 5G core of the wireless communication network. Advantageously, the system and method described herein allows for an automatic process to delete old and/or unused Xn interfaces or Xn relationships of a gNB or direct a handover through an alternative pathway (e.g., via an NG interface) to, for example, mitigate failures of handovers and maintain a good user experience.

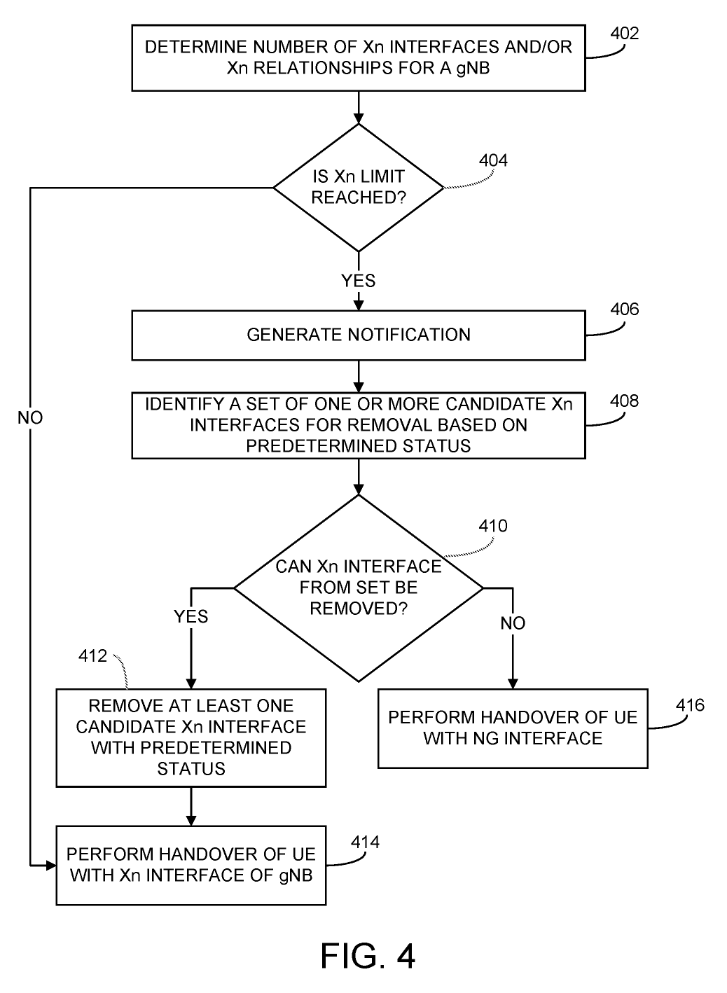

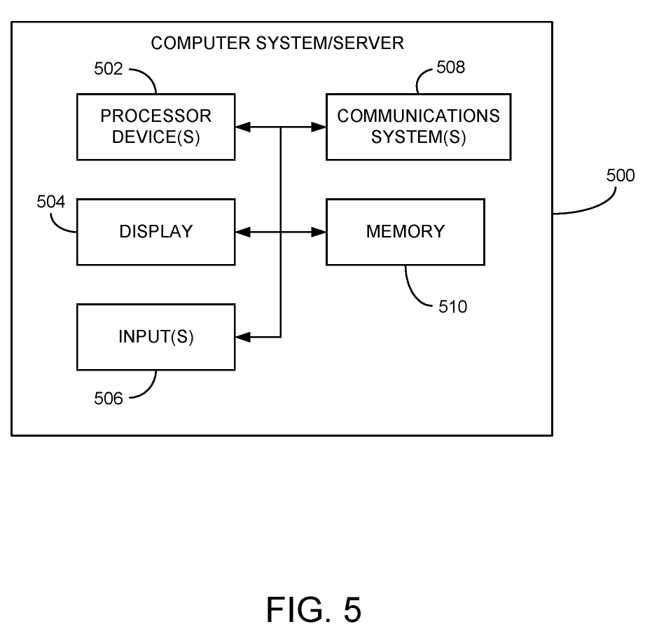

FIG. 4 illustrates a method for managing Xn interface mobility in a wireless communication network in accordance with an embodiment. The process illustrated in FIG. 4 is described as being carried out by the system in FIG. 3A. However, in some examples, the process of FIG. 4 may be implemented by another system. Although the blocks of the process are illustrated in a particular order, in some embodiments, one or more blocks may be executed in a different order than illustrated in FIG. 4, or may be bypassed. The method may be performed by a processing system including at least one electronic processor, where the at least one electronic processor may be or include a processor as previously described (e.g., including one or more individual processor devices) and/or as described further below with respect to FIG. 5.

At block 402, a number of Xn interfaces of a gNB (e.g., a source gNB for a handover) 304 and/or a number of Xn relationships for cells of the gNB 304 can be determined. In some embodiments, the determined numbers are the current number of Xn interfaces of the gNB 304 and the current number of Xn relationships for cells of the gNB 304. The determination at block 402 can be triggered, in some embodiments, by a request for a handover of a UE 310 from the source gNB 304 to a target gNB 306 (or from a source cell of gNB 304 to a target cell of gNB 306), the addition of an Xn interface or Xn relationship for the gNB 304 for a handover of the UE 310, or the detection of an issue with the performance of the source gNB 304. In some embodiments, an Xn interface can be added using a process such as a manual process (e.g., by an administrator of the wireless communication network) or an Automatic Neighbor Relations (ANR) process. In some embodiments, the determination of failures from an Xn 308 can be performed using a machine learning model.

At block 404, it can be determined whether an Xn limit for the gNB 304 (e.g., a source gNB for a handover) is reached or exceeded by the current number of Xn interfaces of the gNB 304 and/or the current number of Xn relationships for cells of the gNB 304 determined at block 402. As discussed above, the Xn limit can be a predetermined limit for the number of Xn interfaces of the gNB 304 and/or the number of Xn relationships for cells of the gNB 304. The determination at block 404 can be performed, for example, by comparing the current number of Xn interfaces of the gNB 304 and/or the current number of Xn relationships for cells of the gNB 304 to the Xn limit for the number of Xn interfaces of the gNB 304 and/or the number of Xn relationships for cells of the gNB 304. In some embodiments, the determination of whether the Xn limit for the gNB has been reached or exceeded can be determined using machine learning. At block 406, if the Xn limit (either the number of Xn interfaces of the gNB 304 and/or the number of Xn relationships for cells of the gNB 304) has not been reached or exceeded, the process can move to block 414 and a handover of the UE 310 from the source gNB 304 to the target gNB 306 can be performed using an Xn interface 308 of the source gNB 304. If, at block 406, it is determined that the Xn limit (either the number of Xn interfaces of the gNB 304 and/or the number of Xn relationships for cells of the gNB 304) has been reached or exceeded, the process can move to block 406 and a notification (or alarm can be generated. In some embodiments, the generated notification can be, for example, transmitted to another component of the NG-RAN 302 or the 5G core 312, or can be transmitted and/or displayed to a user or administrator of the wireless communication network (e.g., using a display of a user interface such as display 504 and inputs 506 of computer system 500 described below with respect to FIG. 5).

At block 408, a set of one or more candidate Xn interfaces (and/or Xn relationships) of the source gNB 304 for the handover can be identified based on a predetermined status of the Xn interface (and/or Xn relationships). In some embodiments, the predetermined status can be an age or level of use of the Xn interface (and/or Xn relationships). For example, older Xn interfaces (and/or Xn relationships) can be identified based on a number of days the Xn interface (or Xn relationship) has been in use the number pf handover mobility attempts for the Xn interface or Xn relationship. In another example, the level of use of the Xn interface or Xn relationship can be whether the Xn interface is used very little or is unused. In some embodiments, a level of use for an Xn interface or Xn relationship can be determined based on use data collected over a predetermined period of time (e.g., one to two weeks).

At block 410, it can be determined if at least one of the candidate Xn interfaces (and/or Xn relationships) identified at block 408 can be removed or deleted. If, at block 410, one or more Xn interfaces and/or Xn relationships for the source gNB 304 can be removed, then at block 412, the one or more Xn interfaces (and/or Xn relationships) of the gNB 304 can be removed. In some embodiments, the removal of one or more Xn interfaces (and/or Xn relationships) of the source gNB 304 for a handover can allow for the addition of one or more new Xn interfaces (and/or Xn relationships) for the source gNB 304 without reaching and/or exceeding the Xn limit. In some embodiments, the determination of candidate Xn interfaces (and/or Xn relationships) and whether they can be removed can be performed using a machine learning model. At block 414, a handover of the UE 310 from the source gNB 304 to the target gNB 306 can then be performed using an Xn interface (or an Xn relationship of the Xn interface) of the source gNB 304. In some embodiments, the Xn interface used for the handover can be an existing Xn interface (or Xn relationship) or can be a newly added Xn interface (or Xn relationship).

If, at block 410, it is determined that none of the candidate Xn interfaces (and/or Xn relationships can be removed, the process can move to block 416. At block 416, the handover of the UE 310 from the source gNB 304 to the target gNB 306 can be performed using an NG interface between the 5G core 312 and the gNBs 304, 306 to, for example, avoid a failure. For example, the NG interface 314 between the source gNB 304 and the 5G core 312 and the NG interface 316 between the target gNB 306 and the 5G core 312 may be used to perform the handover of UE 310 from the source gNB 304 to the target gNB 306.

As mentioned above, various components of the system and process described with respect to FIGS. 1-4 can be performed with a machine learning model. The machine learning model used for each of these components can be, for example, decision tree learning, association rule learning, an artificial neural network (e.g., a convolutional neural network (CNN), a generative adversarial network (GAN)), inductive logic programming, support vector machine, clustering, Bayesian network, reinforcement learning, representation learning, similarity and metric learning, sparse dictionary learning, and genetic algorithms. The machine learning model can be trained using known methods such as supervised learning, self-supervised learning, semi-supervised learning, etc. As one example, to perform supervised learning, the training data includes example inputs and corresponding desired (for example, actual) outputs, and the machine learning model progressively develops a model that maps inputs to the outputs included in the training data. As another example, to perform self-supervised learning, a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data).

As mentioned above, various components of the disclosed system and method may be implemented on a computer system (e.g., a server). FIG. 5 is a schematic block diagram of an example computer system in accordance with an embodiment. The computer system 500 (e.g., a server) may include one or more processor devices 502, a display 504, one or more inputs 506, one or more communication systems 508, and memory 510. In some embodiments, processor device(s) 502 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 502 may include one or more processors, processor cores, processing elements, processor clusters, or other electronic processing units. Accordingly, a processing function described as being performed by the processor device(s) 502 may include multiple processors, processor cores, processing elements, processing clusters, etc. (of the processor device(s) 502) performing aspects or portions (sub-functions) of the processing function to complete the processing function. The one or more electronic processing units of the processor device(s) 502 may include one or more microprocessors, application-specific integrated circuits (“ASICs”), or other suitable electronic device for processing data. At least in some examples, the one or more electronic processing units of the processor device(s) 502 can be co-located physically (e.g., in the same facility, building, room, rack, or computing housing) as part of the computer system 500.

In some embodiments, display 504 can include any suitable display devices, such as a computer monitor, a touchscreen, a television, etc. In some embodiments, display 504 can be omitted. In some embodiments, inputs 506 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for handling Xn interface mobility in a wireless communication network. In some embodiments, inputs 506 can be omitted.

In some embodiments, communications system(s) 508 can include any suitable hardware, firmware, and/or software for communicating information over any suitable communication network (e.g., wireless communication network 100 shown in FIG. 1). For example, communication system(s) 508 can include one or more transceivers, one or more communication chips and/or chip sets, etc. In a more particular example, communication system(s) 508 can include hardware, firmware and/or software that can be used to establish a Wi-Fi connection, a Bluetooth connection, a cellular connection an Ethernet connection, etc.

In some embodiments, memory 510 can include any suitable storage device or devices (e.g., one or more non-transitory computer readable media) that can be used to store instructions, values, etc., that can be used, for example, by processor device 502 to present content using display 504, to communicate with a communication network, to communicate with other computer systems, etc. Memory 510 can include any suitable volatile memory, non-volatile memory, storage, or any suitable combination thereof. For example, memory 510 can include RAM, ROM, EEPROM, one or more flash drives, one or more hard disks, one or more solid state drives, one or more optical drives, etc. The memory 510 may store data and/or instructions for use and execution by the computer system 500 (e.g., by the processor device(s) 502) to implement the functionality of, for example, a system and method for handling Xn interface mobility in a wireless communication network, described herein. In some embodiments, the functionality described herein as being performed by the computer system 500 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A system for managing Xn interface mobility in a wireless communication network, the system comprising:
a memory that stored one or more computer readable media that includes instructions; and
one or more processor devices configured to execute the instructions of the computer readable media to:
determine a number of Xn interfaces for a source gNodeB (gNB) and a number of Xn relationships for cells for the source gNB;
determine when an Xn limit is reached based on one or more of the number of Xn interfaces for the source gNB and the number of Xn relationships for cells for the source gNB;
generate a notification when the Xn limit is reached;
identify a set of one or more candidate Xn interfaces of the source gNB based on a predetermined status;
when at least one of the candidate Xn interfaces is removable, remove the at least one removable candidate Xn interface; and
perform a handover of a user equipment (UE) device from the source gNB to a target gNB using one of the Xn interfaces of the source gNB.

2. The system according to claim 1, wherein when none of the candidate Xn interfaces is removable, the one or more processor devices are configured to further execute the instructions of the computer readable media to perform a handover of the UE device from the source gNB to a target gNB using an NG interface.

3. The system according to claim 1, wherein the Xn limit is a limit of the number of Xn interfaces for the source gNB.

4. The system according to claim 1, wherein the Xn limit is a limit of the number of Xn relationships for cells for the source gNB.

5. The system according to claim 1, wherein the predetermined status is one or more of an age of the Xn interface or a level of use of the Xn interface.

6. The system according to claim 1, wherein removing the at least one removable candidate Xn interface comprises removing an Xn relationship for a cell for the source gNB.

7. The system according to claim 1, wherein the one or more processor devices are configured to further execute the instructions of the computer readable media to add a new Xn interface for the source gNB.

8. A method for managing Xn interface mobility in a wireless communication network, the method comprising:
determining, using a processor device, a number of Xn interfaces for a source gNB and a number of Xn relationships for cells for the source gNB;
determining, using the processor device, when an Xn limit is reached based on one or more of the number of Xn interfaces for the source gNodeB (gNB) and the number of Xn relationships for cells for the source gNB;
generating, using the processor device, a notification when the Xn limit is reached;
identifying. using the processor device, a set of one or more candidate Xn interfaces of the source gNB based on a predetermined status;
when at least one of the candidate Xn interfaces is removable, removing, using the processor device, the at least one removable candidate Xn interface; and
performing, using the processor device, a handover of a user equipment (UE) device from the source gNB to a target gNB using one of the Xn interfaces of the source gNB.

9. The method according to claim 8, the method further comprising, when none of the candidate Xn interfaces is removable, performing, using the processor device, a handover of the UE device from the source gNB to a target gNB using an NG interface.

10. The method according to claim 8, wherein the Xn limit is a limit of the number of Xn interfaces for the source gNB.

11. The method according to claim 8, wherein the Xn limit is a limit of the number of Xn relationships for cells for the source gNB.

12. The method according to claim 8, wherein the predetermined status is one or more of an age of the Xn interface or a level of use of the Xn interface.

13. The method according to claim 8, wherein removing the at least one removable candidate Xn interface comprises removing, using the processor device, an Xn relationship for a cell for the source gNB.

14. The method according to claim 8, further comprising adding, using the processor device, a new Xn interface for the source gNB.

15. A non-transitory, computer-readable medium storing instructions that, when executed by a processor perform a set of functions for managing Xn interface mobility in a wireless communication network, the set of functions comprising:
determining a number of Xn interfaces for a source gNodeB (gNB) and a number of Xn relationships for cells for the source gNB;
determining when an Xn limit is reached based on one or more of the number of Xn interfaces for the source gNB and the number of Xn relationships for cells for the source gNB;
generating a notification when the Xn limit is reached;
identifying a set of one or more candidate Xn interfaces of the source gNB based on a predetermined status;
when at least one of the candidate Xn interfaces is removable, removing the at least one removable candidate Xn interface; and
performing a handover of a user equipment (UE) device from the source gNB to a target gNB using one of the Xn interfaces of the source gNB.

16. The non-transitory computer-readable medium according to claim 15, wherein the set of functions further comprises, when none of the candidate Xn interfaces is removable, performing a handover of the UE device from the source gNB to a target gNB using an NG interface.

17. The non-transitory computer-readable medium according to claim 15, wherein the Xn limit is a limit of the number of Xn interfaces for the source gNB.

18. The non-transitory computer-readable medium according to claim 15, wherein the Xn limit is a limit of the number of Xn relationships for cells for the source gNB.

19. The non-transitory computer-readable medium according to claim 15, wherein the predetermined status is one or more of an age of the Xn interface or a level of use of the Xn interface.

20. The non-transitory computer-readable medium according to claim 15, wherein removing the at least one removable candidate Xn interface comprises removing an Xn relationship for a cell for the source gNB.
